(19) United States
(12) Patent Application Publication
(10) Pub. No.: US 2013/0275370 A1
(43) Pub. Date: Oct. 17, 2013

(54) Label Content Update System for Nutritional Substances

(71) Applicant: Eugenio Minvielle, Rye, NY (US)

(72) Inventor: Eugenio Minvielle, Rye, NY (US)

(21) Appl. No.: 13/646,632

(22) Filed: Oct. 5, 2012

Related U.S. Application Data
(63) Continuation-in-part of application No. 13/485,883, filed on May 31, 2012.
(60) Provisional application No. 61/624,915, filed on Apr. 16, 2012.
(60) Provisional application No. 61/624,925, filed on Apr. 16, 2012.
(60) Provisional application No. 61/624,934, filed on Apr. 16, 2012.

(51) Int. Cl. G06F 17/30

(52) U.S. Cl. 707/609; 707/E17.005

(57) ABSTRACT

In a label content update system for nutritional substances, the labeling content contained in an information system can be changed by the creator or provider if new information regarding the labeling content is acquired by the creator or provider. The information system obtains information regarding a nutritional substance from the creation of the nutritional substance, the preservation of the nutritional substance, the transformation of the nutritional substance, the conditioning of the nutritional substance, and the consumption of the nutritional substances. The information system stores and provides this information to the various constituents of the nutritional substance supply system.

### RELATED PATENT APPLICATIONS

This application is a continuation-in-part of U.S. patent application Ser. No. 13/485,883, filed May 31, 2012, which claims priority to U.S. Provisional Application Ser. No. 61/624,915, filed Apr. 16, 2012; U.S. Provisional Patent Application Ser. No. 61/624,925, filed Apr. 16, 2012; and U.S. Provisional Patent Application, 61/624,934, filed Apr. 16, 2012, each of which is hereby incorporated by reference herein in its entirety.

### FIELD OF THE INVENTION

The present inventions relate to an information system for collecting, transmitting and acting upon information during the harvesting, preserving, transforming, conditioning and/or consumption of nutritional substance.

### BACKGROUND OF THE INVENTION

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. It would be desirable for such information be available to the consumers of nutritional substances, as well as all participants in the food and beverage industry—the nutritional substance supply system.

While the nutritional substance supply system has endeavored over the last 50 years to increase the caloric content of nutritional substances produced (which has help reduce starvation in developing countries, but has led to obesity problems in developed countries), maintaining, or increasing, the nutritional content of nutritional substances has been a lower priority. Caloric content refers to the energy in nutritional substances, commonly measured in calories. The caloric content could be represented as sugars and/or carbohydrates in the nutritional substances. The nutritional content, also referred to herein as nutritional value, of foods and beverages, as used herein, refers to the non-caloric content of these nutritional substances which are beneficial to the organisms which consume these nutritional substances. For example, the nutritional content of a nutritional substance could include vitamins, minerals, proteins, and other non-caloric components which are necessary, or at least beneficial, to the organism consuming the nutritional substances.

While there has recently been greater attention by consumer organizations, health organizations and the public to the nutritional content of foods and beverages, the food and beverage industry has been slow in responding to this attention. One reason for this may be that since the food and beverage industry operates as silos of those who create nutritional substances, those who preserve and transport nutritional substances, those who transform nutritional substances, and those who finally prepare the nutritional substances for consumption by the consumer, there has been no system wide coordination or management of nutritional content, and no practical way for creators, preservers, transformers, and conditioners to update labeling content for nutritional substances. While each of these silo industries may be able to maintain or increase the nutritional content of the foods and beverages they handle, each silo industry has only limited information and control of the nutritional substances they receive, and the nutritional substances they pass along.

As consumers better understand their need for nutritional substances with higher nutritional content, they will start demanding that the food and beverage industry offer products which include higher nutritional content, and/or at least information regarding nutritional content of such products, as well as information regarding the source, creation and other origin information for the nutritional substance. In fact, consumers are already willing to pay higher prices for higher nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or increase the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transform, condition, and record nutritional content for nutritional substances. Of particular importance is the measurement, estimation, and tracking of changes to the nutritional content of a nutritional substance from creation to consumption. This information could be used, not only by the consumer in selecting particular nutritional substances to consume, but could be used by the other food and beverage industry silos, including creation, preservation, transformation, and conditioning, to make decisions on how to create, handle and process nutritional substances. Additionally, those who sell nutritional substances to consumers, such as restaurants and grocery stores, could communicate perceived qualitative values of the nutritional substance in their efforts to market and position their nutritional substance products. Further, a determinant of price of the nutritional substance could be particular nutritional, organoleptic, or aesthetic values, and if changes to those values are perceived as desirable. For example, if a desirable value has been maintained, improved, or minimally degraded, it could be marketed as a premium product. Still further, a system allowing creators, preservers, transformers, and conditioners of nutritional substances to update labeling content to reflect the most current information about the nutritional substance would provide consumers with the information they need to make informed decisions regarding the nutritional substances the purchase and consume. Such information updates could include nutritional, organoleptic, or aesthetic values of the nutritional substance, and may further include information regarding the source, creation and other origin information for the nutritional substance.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely keep her opinions on the quality of the dinner to herself, unless it was an especially bad experience, where she might contact the producer's customer support program to complain. Very minimal, or no, information on the nutritional content of the ready-to-eat dinner is passed along to the consumer. The consumer knows essentially nothing about changes (generally a degradation, but could be a maintenance or even an improvement) to the nutritional content of the sweet corn from creation, processing, packaging, cooking, preservation, preparation by consumer, and finally consumption by the consumer. The consumer is even more unlikely to be aware of possible changes to labeling content that a creator, preserver, transformer, or conditioner may just have become be aware of, such as changes in information about nutritional, organoleptic, or aesthetic values of the nutritional substance or changes in information regarding the source, creation and other origin information about the nutritional substance. If communicated, such changes or updates to labeling content could affect a purchasing preference or consumption preference of a consumer. Further, if communicated, such changes to labeling content could affect the health, safety, and wellbeing of the consumer. It is also understood that such changes would best be communicated rapidly and by a means readily utilized by a consumer to retrieve such changes or updates.

Consumers' needs are changing as consumers are demanding healthier foods, such as “organic foods.” Customers are also asking for more information about the nutritional substances they consume, such as specific characteristics' relating not only to nutritional content, but to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready-to-eat dinner does not know the nutritional content and organoleptic state and aesthetic condition of the product after it has been reheated or cooked by the consumer, cannot predict changes to these properties, and cannot inform a consumer of this information to enable the consumer to better meet their needs. For example, the consumer may want to know what proportion of desired organoleptic properties or values, desired nutritional content or values, or desired aesthetic properties or values of the corn in the ready-to-eat dinner remain after cooking or reheating, and the change in the desired nutritional content or values, the desired organoleptic properties or values, or the desired aesthetic properties or values (usually a degradation, but could be a maintenance or even improvement). There is a need to preserve, measure, estimate, store and/or transmit information regarding such nutritional, organoleptic, and aesthetic values, including changes to these values, throughout the nutritional substance supply system. Given the opportunity and a system capable of receiving and processing real time consumer feedback and updates regarding changes in the nutritional, organoleptic, and/or aesthetic value of nutritional substances, consumers can even play a role in updating dynamic information about the nutritional substances they have purchased and/or prepared for consumption, such that that information is available and useful to others in the nutritional substance supply system.

The caloric and nutritional content information for a prepared food that is provided to the consumer is often minimal. For example, when sugar is listed in the ingredient list, the consumer generally does receive any information about the source of the sugar, which can come from a variety of plants, such as sugarcane, beets, or corn, which will affect its nutritional content. Conversely, some nutritional information that is provided to consumers is so detailed, the consumer can do little with it. For example, this this of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, 211 mg 53%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2.1 g, Polysaturated Fat 3.6 g, Omega 3 fatty acids 108 g, Omega 6 fatty acids 3481, Ash 2.0 g and Water 17.2 g. (%=Daily Value). There is a need to provide information about nutritional substances in a meaningful manner. Such information needs to be presented in a manner that meets the specific needs of a particular consumer. For example, consumers with a medical condition, such as diabetes, would want to track specific information regarding nutritional values associated with sugar and other nutrients in the foods and beverages they consume, and would benefit further from knowing changes in these values or having tools to quickly indicate or estimate these changes in a retrospective, current, or prospective fashion, and even tools to report these changes, or impressions of these changes, in a real-time fashion.

In fact, each silo in the food and beverage industry already creates and tracks some information, including caloric and nutritional information, about their product internally. For example, the framer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional content occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional, organoleptic, and aesthetic value, could be preserved and improved. Consumers could be better informed about nutritional substances they select and consume, including the state, and changes in the state, of the nutritional substance throughout its lifecycle from creation to consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. Collecting, preserving, measuring and/or tracking information about a nutritional substance in the nutritional substance supply system, would allow needed accountability. There would be nothing to hide.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

All through the nutritional substance supply and consumption chain the various suppliers benefit from feedback from consumers further up the supply chain. However, such feedback is disorganized and haphazard and can only be traced generally to the actual nutritional substances being commented on.

An important issue in the creation, preservation, transformation, conditioning, and consumption of nutritional substances are the changes that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to provide a communication system which collects, tracks, and organizes information from each stage of the production of nutritional substances from creation to consumption. It is a further object of the present invention to use such information to modify the creation, packaging, transformation, conditioning and consumption of nutritional substances. It is a further object of the present invention to track and estimate changes in nutritional, organoleptic, and/or aesthetic values of the nutritional substance, such changes herein referred as ΔN, from creation through consumption. It is a further object of the present invention to do so in a manner that minimizes degradation and/or preserves and/or enhances the nutritional value and/or organoleptic value and/or aesthetic value of the nutritional substances across their lifecycle.

It is a further object of the present invention to collect, store and provide information on the consumer of the nutritional substance, including information regarding nutritional, organoleptic, and/or aesthetic values of the nutritional substance.

It is an object of the present invention to track changes and/or minimize and/or track degradation of nutritional, organoleptic, and/or aesthetic value of nutritional substances, or ΔN, and/or collect, store, and/or transmit information regarding this degradation.

It is an object of the present invention to provide all constituents in the nutritional supply system, including the final consumer, with dynamic information about a current or estimated state of nutritional, organoleptic, and/or aesthetic value, and/or changes to such value (ΔN). It is a further object of the present invention to provide consumers with the tools to verify ΔN, along with other source or nutritional substance attributes of interest, prior to and/or during and/or after purchase and prior to and/or after preparation and prior to consumption.

It is an object of the present invention to provide nutritional substance creators, preservers, packagers, transformers, and conditioners the ability to dynamically update nutritional substance labeling content in a manner that makes the updated content available for consumers upon update. In other words, the labeling content, and any updates to the labeling content, are available upon update by nutritional substance creators, preservers, packagers, transformers, and conditioners. For example, an update in labeling content for the beans used in a can of soup would immediately be available to consumers shopping in a grocery store, consumers and restaurants preparing a meal, transformers manufacturing a frozen meal using the beans, and so on, if the update were communicated and retrieved by wireless communication.

### SUMMARY OF THE INVENTION

Other advantages and features will become apparent from the following description and claims. It should be understood that the description and specific examples are intended for purposes of illustration only and not intended to limit the scope of the present disclosure.

In one embodiment of the present invention, information relating to the creation or origin of a nutritional substance is passed along, provided, forwarded, transmitted, or otherwise communicated to, and accessed, received, retrieved or traced by, any precedent or subsequent user or consumer of the nutritional substance. Similarly, information regarding the packaging of a nutritional substance is also passed along, provided, forwarded, transmitted, or otherwise communicated to, and accessed, received, retrieved or traced by, any precedent or subsequent user or consumer of the nutritional substance. Additionally, information regarding the transformation of a nutritional substance is passed along, provided, forwarded, transmitted, or otherwise communicated to, and accessed, received, retrieved or traced by, any precedent or subsequent user or consumer of the nutritional substance, providing access to experts, professionals and the consumer of the nutritional substance and can be used to make nutritional substance selection as well as to modify nutritional substance preparation, trace its origin, determine a ΔN, or determine a state of nutritional, organoleptic, and/or aesthetic value throughout its nutritional substance industry cycle and provide access to information related to the nutritional substance stored in a nutritional substance information database or generated in real time across the globe.

In an embodiment of the present invention, means are provided relating label content of a nutritional substance to a state or estimate of nutritional, organoleptic, or aesthetic value of the nutritional substance, to ΔN information of the nutritional substance, or to creation information or origin information of the nutritional substance, comprising one or more of a dynamic nutritional substance database that is part of an information system for nutritional substances, a dynamic nutritional value database, a dynamic nutritional value table, and a dynamically generated nutritional value table.

In a further embodiment of the present invention, means relating label content of a nutritional substance to a state or estimate of nutritional, organoleptic, or aesthetic value of the nutritional substance or to ΔN information of the nutritional substance further comprises a dynamic information identifier or source information unique to the nutritional substance.

In another embodiment of the present invention, ΔN information or a state or estimate of a nutritional, organoleptic, or aesthetic value of the nutritional substance could include observed or measured information reported by a consumer.

In another embodiment of the present invention, ΔN information or a state or estimate of a nutritional, organoleptic, or aesthetic value of the nutritional substance could include observed or measured or newly revised information from a creator, preserver, transformer, or conditioner.

In another embodiment of the present invention, a system is provided allowing creators, preservers, transformers, and conditioners of nutritional substances to change or update labeling content to reflect newly acquired information about the nutritional substance that they have supplied to another entity in order to provide consumers with information needed to make informed decisions regarding purchase or consumption the nutritional substance. Such information updates could include nutritional, organoleptic, or aesthetic values of the nutritional substance that has changed from that originally included as part of the labeling content, and may further include information regarding the source, creation and other origin information for the nutritional substance that has changed from that originally included as part of the labeling content. It is preferred that such changes to labeling content are communicated quickly and easily, such as by wireless communication or internet.

In another embodiment of the present invention, a system is provided allowing creators, preservers, transformers, and conditioners of nutritional substances to change or update labeling content to reflect newly required information about the nutritional substance that they have supplied to another entity in order to comply with new local, state, or national laws or regulations. Such information updates could include nutritional, organoleptic, or aesthetic values of the nutritional substance that have changed from that originally included as part of the labeling content or were not required as part of the original labeling content, and may further include information regarding the source, creation and other origin information for the nutritional substance that has changed from that originally included as part of the labeling content or were not required as part of the original labeling content. It is further understood that the label content requirements can vary depending on local, state, and national regulations, and that changes to labeling content requirements can be based upon changes to local, state, or national regulations.

In a preferred embodiment a dynamic nutritional value database contains labeling content required in various local, state, and national regions of nutritional substance distribution, and said labeling content is referenced to a dynamic information identifier provided with the nutritional substance or source information unique to the nutritional substance and provided with the nutritional substance.

In a further embodiment of the present invention, means allowing providers of nutritional substances, including creators, preservers, transformers, or conditioners, to change or update labeling content to reflect newly acquired or newly required information about the nutritional substance they have supplied to another entity is any one or more of a communications, data processing, or computer system configurations, including: wireless devices, Internet appliances, hand-held devices (including personal digital assistants or PDAs, wearable computers, all manner of cellular or mobile phones, multi-processor systems, microprocessor-based or programmable consumer electronics, set-top boxes, network PCs, mini-computers, mainframe computers, telecommunication systems, wireless communication systems, internet, e-mail, text message, voice mail, social media, facsimile, and hard copy notice.

In a further embodiment of the present invention, means allowing providers of nutritional substances, including creators, preservers, transformers, or conditioners, to change or update labeling content to reflect newly acquired or newly required information about the nutritional substance they have supplied to another entity further comprises a dynamic information identifier or source information unique to the nutritional substance.

In another embodiment of the present invention, a system is provided allowing creators, preservers, transformers, conditioners, and consumers of nutritional substances to retrieve labeling content that reflects updated information about a nutritional substance, wherein the updated information is based upon information newly acquired by a creator, preserver, transformer, or conditioner of the nutritional substance after that creator, preserver, transformer, or conditioner has provided the nutritional substance to another entity. Such updated information could include nutritional, organoleptic, or aesthetic values of the nutritional substance that have changed from that originally included as part of the labeling content, and may further include information regarding the source, creation and other origin information for the nutritional substance that has changed from that originally included as part of the labeling content. It is preferred that such changes to labeling content are retrievable quickly and easily, such as by wireless communication or internet.

In another embodiment of the present invention, a system is provided allowing creators, preservers, transformers, conditioners, and consumers of nutritional substances to retrieve labeling content that reflects updated information about a nutritional substance, wherein the updated information is based upon information newly required from a creator, preserver, transformer, or conditioner of the nutritional substance after that creator, preserver, transformer, or conditioner has provided the nutritional substance to another entity, in order to comply with new local, state, or national laws or regulations. Such updated information could include nutritional, organoleptic, or aesthetic values of the nutritional substance that have changed from that originally included as part of the labeling content or were not required as part of the original labeling content, and may further include information regarding the source, creation and other origin information for the nutritional substance that has changed from that originally included as part of the labeling content or were not required as part of the original labeling content. It is further understood that the label content requirements can vary depending on local, state, and national regulations, and that changes to labeling content requirements can be based upon changes to local, state, or national regulations.

In a preferred embodiment a dynamic nutritional value database contains labeling content to be retrieved in various local, state, and national regions of nutritional substance distribution, and said labeling content is referenced by a dynamic information identifier provided with the nutritional substance or source information unique to the nutritional substance and provided with the nutritional substance.

In a further embodiment of the present invention, means allowing creators, preservers, transformers, conditioners, or consumers of nutritional substances to retrieve labeling content that reflects updated information about a nutritional substance, wherein the updated information is based upon information newly acquired by, or newly required of, a creator, preserver, transformer, or conditioner of the nutritional substance after that creator, preserver, transformer, or conditioner has provided the nutritional substance to another entity, comprises any one or more of a communications, data processing, or computer system configurations, including: wireless devices, Internet appliances, hand-held devices (including personal digital assistants or PDAs, wearable computers, all manner of cellular or mobile phones, multi-processor systems, microprocessor-based or programmable consumer electronics, set-top boxes, network PCs, mini-computers, mainframe computers, telecommunication systems, wireless communication systems, internet, e-mail, text message, voice mail, social media, facsimile, and hard copy notice.

In a further embodiment of the present invention, means allowing creators, preservers, transformers, conditioners, or consumers of nutritional substances to retrieve labeling content that reflects updated information about a nutritional substance, wherein the updated information is based upon information newly acquired by, or newly required of, a creator, preserver, transformer, or conditioner of the nutritional substance after that creator, preserver, transformer, or conditioner has provided the nutritional substance to another entity further comprises a dynamic information identifier or source information unique to the nutritional substance.

In another embodiment of the present invention, such information could be mapped out regarding the creation, packaging, transformation, and conditioning of the nutritional substance and is used by a subsequent user or consumer of the nutritional substance to modify their use, preservation, transformation and/or conditioning of the nutritional substance.

In another embodiment of the present invention, such information could be mapped out regarding the creation, packaging, transformation, and conditioning of the nutritional substance to be used by a consumer of the nutritional substance to confirm that their intended use, preservation, transformation and/or conditioning of the nutritional substance will result in a nutritional substance that meets their needs, particularly as it relates to a ΔN of the nutritional substance. This eliminates the risks currently faced by consumers associated with having no way of determining such information, and additionally eliminates the liability currently faced by creators, preservers, transformers, and conditioners by not making such information available to consumers.

In another embodiment of the present invention, the information collected by the creator, packager, transformer, conditioner and consumer is stored in a multi-dimensional database for analysis. Additionally, such information is transmitted to the creators, packager, transformers, conditioners and consumers for improvement of the nutritional substance and for process improvement. The transmission of such information can be accomplished using any form of telecommunication, including the internet and wireless communication.

In another embodiment of the present invention, the information collected by the creator, packager, transformer, conditioner and consumer includes observed or measured information reported by a consumer which is stored in a multi-dimensional database for analysis. Additionally, such information is transmitted to the creators, packager, transformers, conditioners and consumers of the nutritional substance. The transmission of such information can be accomplished using any form of telecommunication, including the internet and wireless communication.

In the preferred embodiment of the present invention, information regarding the consumer is used dynamically within the system to modify the creation, preservation, transformation, conditioning and selection of nutritional substances to meet the consumer's needs.

In the preferred embodiment of the present invention, information regarding the consumer is used dynamically within the system to alert the consumer that a selection of a nutritional substance does not meet the consumer's needs or is not consistent with the information regarding the consumer.

An embodiment of the present invention provides a system for the creation, collection, storage, transmission, and/or processing of information regarding nutritional substances so as to improve, maintain, or minimize degradation of nutritional, organoleptic, and/or aesthetic value of nutritional substances. Additionally, the present invention provides such information for use by the creators, preservers, transformers, conditioners, and consumers of nutritional substances. The nutritional information creation, preservation, and transmission system of the present invention should allow the nutritional substance supply system to improve its ability to minimize degradation of nutritional, organoleptic and/or aesthetic value of the nutritional substance, and/or inform the consumer, creator, packager, transformer, or conditioner about such degradation, or ΔN. While the ultimate goal of the nutritional substance supply system is to minimize degradation of nutritional, organoleptic and/or aesthetic values, or as it relates to ΔN, minimize the negative magnitude of ΔN, an interim goal should be providing consumers with significant information regarding any change, particularly degradation, of nutritional, organoleptic and/or aesthetic values of nutritional, and/or component nutritional substances thereof, consumers select and consume, the ΔN, such that desired information regarding specific residual nutritional, organoleptic, and/or aesthetic values can be ascertained using the ΔN. Entities within the nutritional substance supply system who provide such ΔN information regarding nutritional substances, particularly regarding degradation, will be able to differentiate their products from those who obscure and/or hide such information. Additionally, such entities should be able to charge a premium for products which either maintain their nutritional, organoleptic, and/or aesthetic value, or supply more complete information about changes in their nutritional, organoleptic, and/or aesthetic value, the ΔN. Further, entities that supply conditioning equipment and other devices enabling consumer access and utilization of ΔN information will be able to differentiate their products from those that do not enable the consumer to access and utilize ΔN information. Such conditioning equipment will allow consumers to minimize degradation of, preserve, or improve the nutritional, organoleptic, and/or aesthetic value of the nutritional substances they consume. Such conditioners will further enable the consumer to optimize the nutritional, organoleptic, and/or aesthetic value of the nutritional substances they condition and consume according to their individual needs and/or desires.

In an embodiment of the present invention, observed or measured ΔN information can also be provided by consumers, so that it can be received and reflected through reporting or modification of a nutritional substance database. In this way, consumer reports regarding observed or measured changes in nutritional, organoleptic, and/or aesthetic values of nutritional substances they have purchased, are going to prepare, or are going to consume, are in some way incorporated into a nutritional substance database.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply relating to the present invention;

FIG. 2 shows a graph representing a value of a nutritional substance which changes according to a change of condition for the nutritional substance;

FIG. 3 shows a schematic functional block diagram of a nutritional substance supply relating to an alternate embodiment of the present invention; and

FIG. 4 shows a schematic functional block diagram of a nutritional substance supply relating to an alternate embodiment of the present invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems. It is understood that the communications systems discussed herein are only examples of how nutritional substance information, consumer information, or any other required information can be passed along, provided, forwarded, transmitted, updated, revised, accessed, received, or retrieved according to the present invention, and that any communication means or combination thereof known to one skilled in the art could be utilized.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

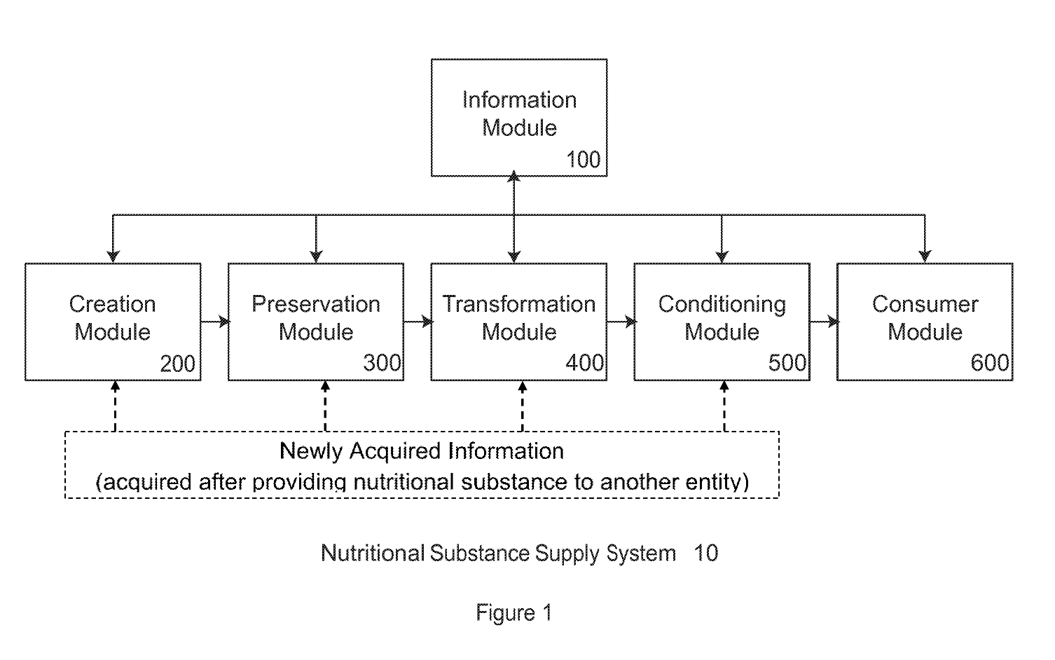

FIG. 1 shows the components of a nutritional substance industry 10. It should be understood that this could be the food and beverage ecosystem for human consumption, but could also be the feed industry for animal consumption, such as the pet food industry. A goal of the present invention for nutritional substance industry 10 is to create, preserve, transform and trace change in nutritional, organoleptic and/or aesthetic values of nutritional substances, collectively and individually also referred to herein as ΔN, through their creation, preservation, transformation, conditioning and consumption. While the nutritional substance industry 10 can be composed of many companies or businesses, it can also be integrated into combinations of business serving many roles, or can be one business or even individual. Since ΔN is a measure of the change in a value of a nutritional substance, knowledge of a prior value (or state) of a nutritional substance and the ΔN value will provide knowledge of the changed value (or state) of a nutritional substance, and can further provide the ability to estimate a change in value (or state).

Module 200 is the creation module. This can be a system, organization, or individual which creates and/or originates nutritional substances. Examples of this module include a farm which grows produce; a ranch which raises beef; an aquaculture farm for growing shrimp; a factory that synthesizes nutritional compounds; a collector of wild truffles; or a deep sea crab trawler.

Preservation module 300 is a preservation system for preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actually can be placed anywhere nutritional substances need to be preserved during their transition from creation to consumption.

Transformation module 400 is a nutritional substance processing system, such as a manufacturer who processes raw materials such as grains into breakfast cereals. Transformation module 400 could also be a ready-to-eat dinner manufacturer who receives the components, or ingredients, also referred to herein as component nutritional substances, for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding a nutritional substance between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. Information module 100 contains a database, also referred to herein as a dynamic nutritional value database, where the information regarding the nutritional substance resides. It is understood that the information contained in information module 100 comprises at least a portion of the labeling content for the corresponding nutritional substance, and can be accessed using reference information or encoding provided with the product, as will be explained further. Information module 100 can be connected to the other modules by a variety of communication systems, such as paper, computer networks, the internet and telecommunication systems, such as wireless telecommunication systems. It is understood that the communications systems discussed herein are only examples of how nutritional substance information, consumer information, or any other required information can be provided, forwarded, transmitted, updated, revised, accessed, received, or retrieved according to the present invention, and that any communication means or combination thereof known to one skilled in the art could be utilized. In a system capable of receiving and processing real time consumer feedback and updates regarding changes in the nutritional, organoleptic, and/or aesthetic value of nutritional substances, or ΔN, consumers can even play a role in updating a dynamic nutritional value database with observed or measured information about the nutritional substances they have purchased and/or prepared for consumption, so that the information is available and useful to others in the nutritional substance supply system, such as through reports reflecting the consumer input or through modification of ΔN. In a system capable of receiving and processing creator, preserver, transformer, or conditioner updates regarding a ΔN or other attribute of a nutritional substance they have created or processed and provided to another entity, the creator, preserver, transformer, or conditioner can play a role in revising a dynamic nutritional value database with observed or measured or newly acquired information about the nutritional substances they have previously created or processed, so that the revised information is available and useful to others in the nutritional substance supply system, such as through reports reflecting such input or through modification of ΔN, or modification of information regarding the source, creation and other origin information for the nutritional substance.

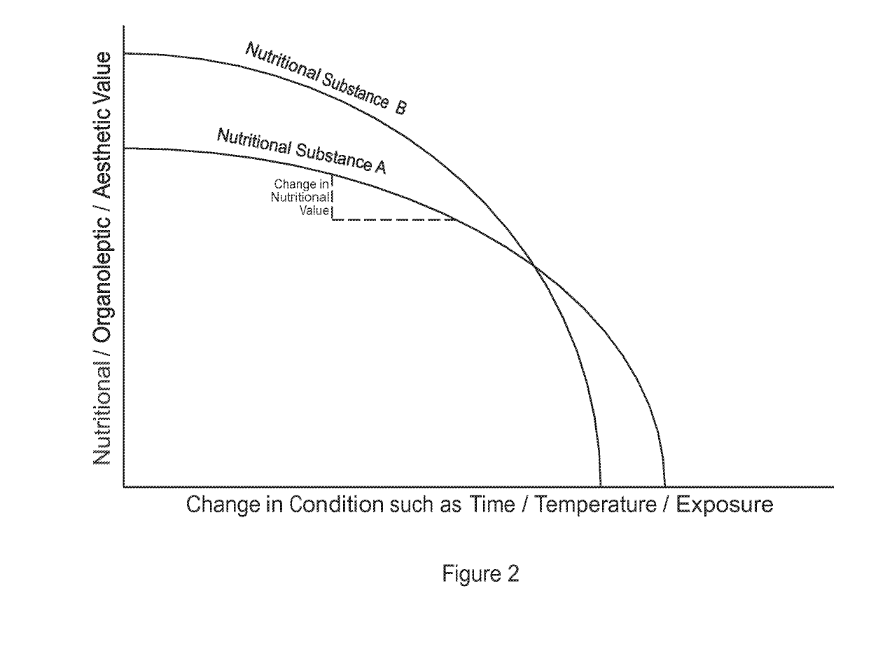

FIG. 2 is a graph showing the function of how a nutritional, organoleptic, or aesthetic value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of the nutritional substance over a variable such as time, temperature, location, and/or exposure to environmental conditions. This exposure to environmental conditions can include: exposure to air, including the air pressure and partial pressures of oxygen, carbon dioxide, water, or ozone; airborne chemicals, pollutants, allergens, dust, smoke, carcinogens, radioactive isotopes, or combustion byproducts; exposure to moisture; exposure to energy such as mechanical impact, mechanical vibration, irradiation, heat, or sunlight; or exposure to materials such as packaging. The function plotted as nutritional substance A could show a ΔN for milk, such as the degradation of a nutritional value of milk over time. Any point on this curve can be compared to another point to measure and/or describe the change in nutritional value, or the ΔN of nutritional substance A. The plot of the degradation in the same nutritional value of nutritional substance B, also milk, describes the change in nutritional value, or the ΔN of nutritional substance B, a nutritional substance which starts out with a higher nutritional value than nutritional substance A, but degrades over time more quickly than nutritional substance A.

If, in this example, where nutritional substance A and nutritional substance B are milk, this ΔN information regarding the nutritional substance degradation profile of each milk could be used by the consumer in the selection and/or consumption of the milk. If the consumer has this information at time zero when selecting a milk product for purchase, the consumer could consider when the consumer plans to consume the milk, whether that is on one occasion or multiple occasions. For example, if the consumer planned to consume the milk prior to the point when the curve represented by nutritional substance B crosses the curve represented by nutritional substance A, then the consumer should choose the milk represented by nutritional substance B because it has a higher nutritional value until it crosses the curve represented by nutritional substance A. However, if the consumer expects to consume at least some of the milk at a point in time after the time when the curve represented by nutritional substance B crosses the curve represented by nutritional substance A, then the consumer might choose to select the milk represented by the nutritional substance A, even though milk represented by nutritional substance A has a lower nutritional value than the milk represented by nutritional substance B at an earlier time. This change to a desired nutritional value in a nutritional substance over a change in a condition of the nutritional substance described in FIG. 2 can be measured and controlled throughout nutritional substance supply system 10 in FIG. 1. This example demonstrates how dynamically generated information regarding a ΔN of a nutritional substance, in this case a change in nutritional value of milk, can be used to understand a rate at which that nutritional value changes or degrades; when that nutritional value expires; and a residual nutritional value of the nutritional substance over a change in a condition of the nutritional substance, in this example a change in time. This ΔN information could further be used to determine a best consumption date for nutritional substance A and B, which could be different from each other depending upon the dynamically generated information generated for each.

In FIG. 1, Creation module 200 can dynamically encode nutritional substances to enable the tracking of changes in nutritional, organoleptic, and/or aesthetic value of the nutritional substance, or ΔN. This dynamic encoding, also referred to herein as a dynamic information identifier, can replace and/or complement existing nutritional substance marking systems such as barcodes, labels, and/or ink markings. This dynamic encoding, or dynamic information identifier, can be used to make nutritional substance information from creation module 200 available to information module 100 for use by preservation module 300, transformation module 400, conditioning module 500, and/or consumption module 600, which includes the ultimate consumer of the nutritional substance. One method of marking the nutritional substance with a dynamic information identifier by creation module 200, or any other module in nutritional supply system 10, could include an electronic tagging system, such as the tagging system manufactured by Kovio of San Jose, Calif., USA. Such thin film chips can be used not only for tracking nutritional substances, by can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow the dynamic nutritional value database of information module 100 real time, or near real time updates about a ΔN of a particular nutritional substance. The dynamic information identifier can also be utilized by creators, preservers, transformers, and conditioners to change labeling content already residing in information module 100 for nutritional substances they have already provided to another entity according to newly acquired information.

Preservation module 300 includes packers and shippers of nutritional substances. The tracking of changes in nutritional, organoleptic, and/or aesthetic values, or a ΔN, during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information such as ΔN, an actual expiration date, referred to herein as a dynamic expiration date, can be determined dynamically, and could be significantly later in time than an extrapolated expiration date. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives.

It should be noted that a dynamic expiration date need not be indicated numerically (i.e., as a numerical date) but could be indicated symbolically as by the use of colors—such as green, yellow and red employed on semaphores—or other designations. In those instances, the dynamic expiration date would not be interpreted literally but, rather, as a dynamically-determined advisory date. In practice a dynamic expiration date will be provided for at least one component of a single or multi-component nutritional substance. For multi-component nutritional substances, the dynamic expiration date could be interpreted as a “best” date for consumption for particular components

By law, in many localities, food processors such as those in transformation module 400 are required to provide nutritional substance information regarding their products. Often, this information takes the form of a nutritional table applied to the packaging of the nutritional substance. Currently, the information in this nutritional table is based on averages or minimums for their typical product. Using the nutritional substance information from information module 100 provided by creation module 200, preservation module 300, and/or information from the transformation of the nutritional substance by transformation module 400, the food processor could include a dynamically generated nutritional value table, also referred to herein as a dynamic nutritional value table, for the actual nutritional substance being supplied. The information in such a dynamic nutritional value table could be used by conditioning module 500 in the preparation of the nutritional substance, and/or used by consumption module 600, so as to allow the ultimate consumer the ability to select the most desirable nutritional substance which meets their needs, and/or to track information regarding nutritional substances consumed.

Information about changes in nutritional, organoleptic, and/or aesthetic values of nutritional substances, or ΔN, is particularly useful in the conditioning module 500 of the present invention, as it allows knowing, or estimating, the pre-conditioning state of the nutritional, organoleptic, and/or aesthetic values of the nutritional substance, and allows for estimation of a ΔN associated with proposed conditioning parameters. The conditioning module 500 can therefore create conditioning parameters, such as by modifying existing or baseline conditioning parameters, to deliver desired nutritional, organoleptic, and/or aesthetic values after conditioning. The pre-conditioning state of the nutritional, organoleptic, and/or aesthetic value of a nutritional substance is not tracked or provided to the consumer by existing conditioners, nor is the ΔN expected from a proposed conditioning tracked or provided to the consumer either before or after conditioning. However, using information provided by information module 100 from creation module 200, preservation module 300, transformation module 400, and/or information measured or generated by conditioning module 500, conditioning module 500 could provide the consumer with the actual, and/or estimated change in nutritional, organoleptic, and/or aesthetic values of the nutritional substance, or ΔN. Further, consumer feedback and updates regarding observed or measured changes in the nutritional, organoleptic, and/or aesthetic value of nutritional substances, or ΔN, can play a role in updating a dynamic nutritional value database with information about the nutritional substances consumers have purchased and/or prepared for consumption, so that the information is available and useful to others in the nutritional substance supply system, such as through reports reflecting the consumer input or through modification of ΔN. Such information regarding the change to nutritional, organoleptic and/or aesthetic value of the nutritional substance, or ΔN, could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a nutritional substance from information module 100, consumers can use consumption module 600 to select nutritional substances according to nutritional, organoleptic, and/or aesthetic values. This will further allow consumers to make informed decisions regarding nutritional substance additives, preservatives, genetic modifications, origins, traceability, and other nutritional substance attributes that may also be tracked through the information module 100. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to optimize nutritional, organoleptic, and/or aesthetic values of a nutritional substance and/or component nutritional substances thereof according to the consumer's needs or preference, and/or minimize degradation of, preserve, or improve nutritional, organoleptic, and/or aesthetic value of a nutritional substance and/or component nutritional substances thereof.

Through the use of nutritional substance information available from information module 100 nutritional substance supply system 10 can track nutritional, organoleptic, and/or aesthetic value. Using this information, nutritional substances travelling through nutritional substance supply system 10 can be dynamically valued and priced according to nutritional, organoleptic, and/or aesthetic values. For example, nutritional substances with longer dynamic expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity. Therefore, both the starting nutritional, organoleptic, and/or aesthetic value and the ΔN associated with those values are important factors in determining or estimating an actual, or residual, nutritional, organoleptic, and/or aesthetic value of a nutritional substance, and accordingly are important factors in establishing dynamically valued and priced nutritional substances.

During the period of implementation of the present inventions, there will be nutritional substances being marketed including those benefiting from the tracking of dynamic nutritional information such as ΔN, also referred to herein as information-enabled nutritional substances, and nutritional substances which do not benefit from the tracking of dynamic nutritional information such as ΔN, which are not information enabled and are referred to herein as dumb nutritional substances. Information-enabled nutritional substances would be available in virtual internet marketplaces, as well as traditional marketplaces. Because of information provided by information-enabled nutritional substances, entities within the nutritional substance supply system 10, including consumers, would be able to review and select information-enabled nutritional substances for purchase. It should be expected that, initially, the information-enabled nutritional substances would enjoy a higher market value and price than dumb nutritional substances. However, as information-enabled nutritional substances become more the norm, the cost savings from less waste due to degradation of information-enabled nutritional substances could lead to their price actually becoming less than dumb nutritional substances.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

The change to nutritional, organoleptic, and/or aesthetic value for a nutritional substance, or ΔN, tracked through nutritional substance supply system 10 through nutritional substance information from information module 100 can be preferably determined from measured information. However, some or all such nutritional substance ΔN information may be derived through measurements of environmental conditions of the nutritional substance as it travelled through nutritional substance supply system 10. Additionally, some or all of the nutritional substance ΔN information can be derived from ΔN data of other nutritional substances which have travelled through nutritional substance supply system 10. Nutritional substance ΔN information can also be derived from laboratory experiments performed on other nutritional substances, which may approximate conditions and/or processes to which the actual nutritional substance has been exposed. Further, consumer feedback and updates regarding observed or measured changes in the nutritional, organoleptic, and/or aesthetic value of nutritional substances can play a role in updating ΔN information. Also, a creator, preserver, transformer, or conditioner may revise ΔN information, or information regarding other attributes of nutritional substances they have previously created or processed, based upon newly acquired information affecting the ΔN or the other attributes.

For example, laboratory experiments can be performed on bananas to determine effect on or change in nutritional, organoleptic, and/or aesthetic value, or ΔN, for a variety of environmental conditions bananas may be exposed to during packaging and shipment in preservation module 300. Using this experimental data, tables and/or algorithms could be developed which would predict the level of change of nutritional, organoleptic, and/or aesthetic values, or ΔN, for a particular banana based upon information collected regarding the environmental conditions to which the banana was exposed during its time in preservation module 300. While the ultimate goal for nutritional substance supply system 10 would be the actual measurement of nutritional, organoleptic, and/or aesthetic values to determine ΔN, use of derived nutritional, organoleptic, and/or aesthetic values from experimental data to determine ΔN would allow improved logistics planning because it provides the ability to prospectively estimate changes to nutritional, organoleptic, and/or aesthetic values, or ΔN, and because it allows more accurate tracking of changes to nutritional, organoleptic, and/or aesthetic values, or ΔN, while technology and systems are put in place to allow actual measurement.

In FIG. 1, Information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network. Further, if the creation module 200 learns of a change in the information originally provided to information module 100, such as a deviation in a fertilizer or pesticide used or the water used for irrigation, the creation module 200 could update the labeling content related to those attributes and residing in the information module 100.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and corresponding initial nutritional, organoleptic, or aesthetic values of the corn and to whom the corn was delivered could also be collected. The farmer would provide such information to information module 100.

In the case where nutritional substance is beef hamburger meet, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. All such creation information would be provided by the rancher to information module 100.

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Further, if preservation module 300 dynamically modified its preservation of the nutritional substance during its preservation and shipment, information regarding how preservation module 300 dynamically modified itself during the period of preservation and shipment could be provided to information module 100. Still further, if the preservation module 300 learns of a change in the information originally provided to information module 100, such as a deviation in storage conditions, the preservation module 300 could update the labeling content related to those attributes and residing in the information module 100.

In the case where the nutritional substance is bananas, preservation module 300 could provide to information module 100 information about the current state of nutritional, organoleptic, or aesthetic values, or one or more ΔNs of the bananas, as well as the exterior and interior conditions of preservation module 300, as well modifications preservation module 300 made to itself to ripen or preserve the bananas during preservation so as to meet optimal nutritional, organoleptic, or aesthetic properties when the bananas arrive at the grocery store.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef.

Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information. Further, if the transformation module 400 learns of a change in the information it originally provided to information module 100, such as a deviation in component nutritional substance used, the transformation module 400 could update the labeling content related to those component nutritional substances and residing in the information module 100.

In the case where the nutritional substance is sweet corn which is to be cooked and canned for consumer consumption, transformation module 400 could use the creation information regarding the composition of the corn, including its nutrients and additives and any nutritional, organoleptic, or aesthetic values to determine how to transform the corn so as to preserve or improve organoleptic and nutritional properties. Transformation module 400 could also use preservation information regarding the corn to modify the transformation in response to changes to the corn which occurred during preservation so as to optimize at least one ΔN associated with the corn resulting from transformation. Additionally, information regarding how the corn was transformed in transformation module 400, such as cooking temperatures and duration and substances added to the canned corn, could be provided by transformation module 400 to information module 100.

Conditioning module 500 receives information regarding the nutritional substance from information module 100. This information could include: creation information provided by creation module 200, preservation information provided by preservation module 300, and transformation information from transformation module 400. Additionally, conditioning module 500 could receive recipe information from information module 100. All such information could be used by conditioning module 500 in the conditioning of the nutritional substance so as to optimize at least one ΔN associated with the corn resulting from conditioning. Additionally, conditioning module 500 can provide information module 100 with conditioning information regarding how the nutritional substance was conditioned, as well as measured or sensed or estimated information as to the state of the nutritional substance before, during and upon completion of conditioning, or a ΔN associated with conditioning.

In the example of a frozen ready-to-eat dinner, conditioning module 500 could use such information provided by information module 100 to optimize the conditioning of the nutritional substance by conditioning module 500. Conditioning module 500 could dynamically adapt or modify the conditioning of the nutritional substance in response to information it receives from information module 100 regarding the nutritional, organoleptic, or aesthetic properties of the nutritional substance. Conditioning module 500 could use information about nutritional substances used as ingredients of the frozen ready-to-eat dinner, such as the transformed corn and beef described above, to modify the defrosting and cooking the frozen ready-to-eat dinner.

Consumer module 600 obtains consumer information from the consumer of the nutritional substance. Such consumer information could include feedback from the consumer as to the quality and taste of the nutritional substance, and could include feedback used to understand or determine a nutritional, organoleptic, or aesthetic value of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is canned Brussels sprouts, the Brussels sprouts would have creation information provided by creation module 200, preservation information from preservation module 300, and transformation information from transformation module 400 before being delivered to consumer module 600.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through creation module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database.

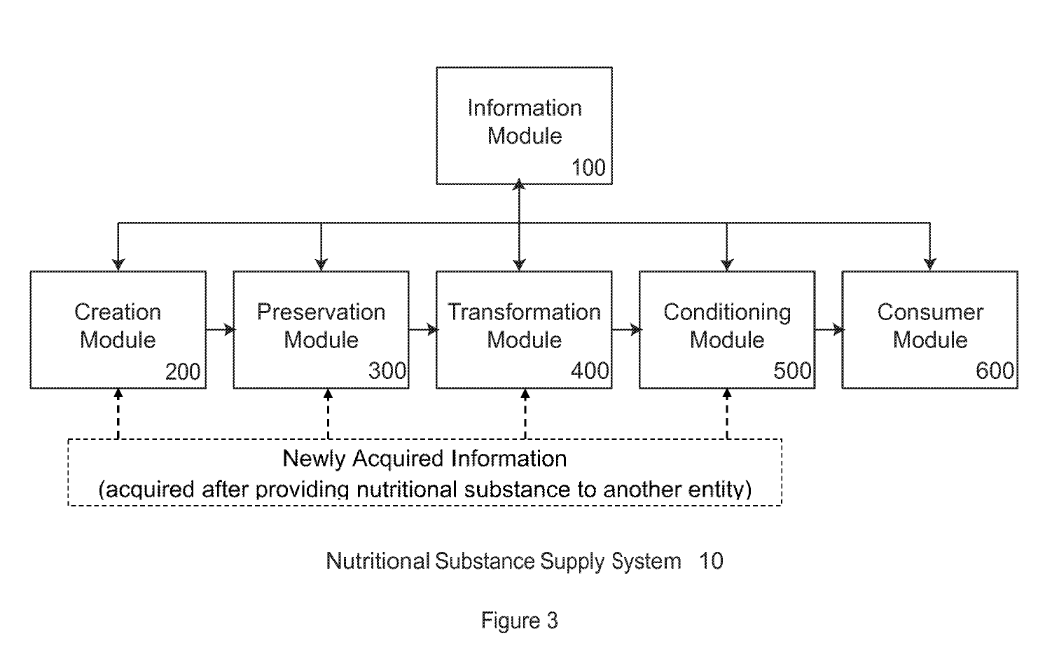

In FIG. 3, information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and corresponding initial nutritional, organoleptic, or aesthetic values of the corn and to whom the corn was delivered could also be collected. The farmer would provide such information to information module 100.

In the case where nutritional substance is beef hamburger meat, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. All such creation information would be provided by the rancher to information module 100.

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is bananas, preservation module 300 could provide to information module 100 information about the current state of nutritional, organoleptic, or aesthetic values, or one or more ΔNs of the bananas, as well as the exterior and interior conditions of preservation module 300, as well modifications preservation module 300 made to itself to ripen or preserve the bananas during preservation so as to meet optimal nutritional, organoleptic, or aesthetic properties when the bananas arrive at the grocery store.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef.

Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information.

In the case where the nutritional substance is sweet corn which is to be cooked and canned for consumer consumption, transformation module 400 could use the creation information regarding the composition of the corn, including its nutrients and additives and any nutritional, organoleptic, or aesthetic values to determine how to transform the corn so as to preserve or improve organoleptic and nutritional properties. Transformation module 400 could also use preservation information regarding the corn to modify the transformation in response to changes to the corn which occurred during preservation so as to optimize at least one ΔN associated with the corn resulting from transformation. Additionally, information regarding how the corn was transformed in transformation module 400, such as cooking temperatures and duration and substances added to the canned corn, could be provided by transformation module 400 to information module 100.

Conditioning module 500 receives information regarding the nutritional substance from information module 100. This information could include creation information provided by creation module 200, preservation information provided by preservation module 300, and transformation information from transformation module 400. Additionally, conditioning module 500 could receive recipe information from information module 100. All such information could be used by conditioning module 500 in the conditioning of the nutritional substance so as to optimize at least one ΔN associated with the corn resulting from conditioning. Additionally, conditioning module 500 can provide information module 100 with conditioning information regarding how the nutritional substance was conditioned, as well as measured or sensed or estimated information as to the state of the nutritional substance before, during and upon completion of conditioning, or a ΔN associated with conditioning.

In the example of a frozen ready-to-eat dinner, conditioning module 500 could use such information provided by information module 100 to optimize the conditioning of the nutritional substance by conditioning module 500. Conditioning module 500 could dynamically adapt or modify the conditioning of the nutritional substance in response to information it receives from information module 100 regarding the nutritional, organoleptic, or aesthetic properties of the nutritional substance. Conditioning module 500 could use information about nutritional substances used as ingredients of the frozen ready-to-eat dinner, such as the transformed corn and beef described above, to modify the defrosting and cooking the frozen ready-to-eat dinner.

Consumer module 600 obtains consumer information from the consumer of the nutritional substance. Such consumer information could include feedback from the consumer as to the quality and taste of the nutritional substance, and could include feedback used to understand or determine a nutritional, organoleptic, or aesthetic value of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is canned Brussels sprouts, the Brussels sprouts would have creation information provided by creation module 200, preservation information from preservation module 300, and transformation information from transformation module 400 before being delivered to consumer module 600.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through creation module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database.

Information module 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Information module 100 could track the nutritional substances consumed to track and manage the diets of consumers. For example, a consumer who is on dialysis must manage the levels of certain chemicals in their blood for the dialysis to be effective. Information module 100 could track such information regarding nutritional substances being consumed. Additionally, information module 100 could provide information to consumer module 600 to assist in nutritional substance selection, including menu planning. This could include not only suggestions as to nutritional substances to be consumed, but also nutritional substances that should not be consumed and alerts or warnings when a consumer may be considering the purchase, consumption, or conditioning of a nutritional substance that should not be consumed. Further, such information from information module 100 could allow consumer module 600 to suggest compromises in the selection of nutritional substances.

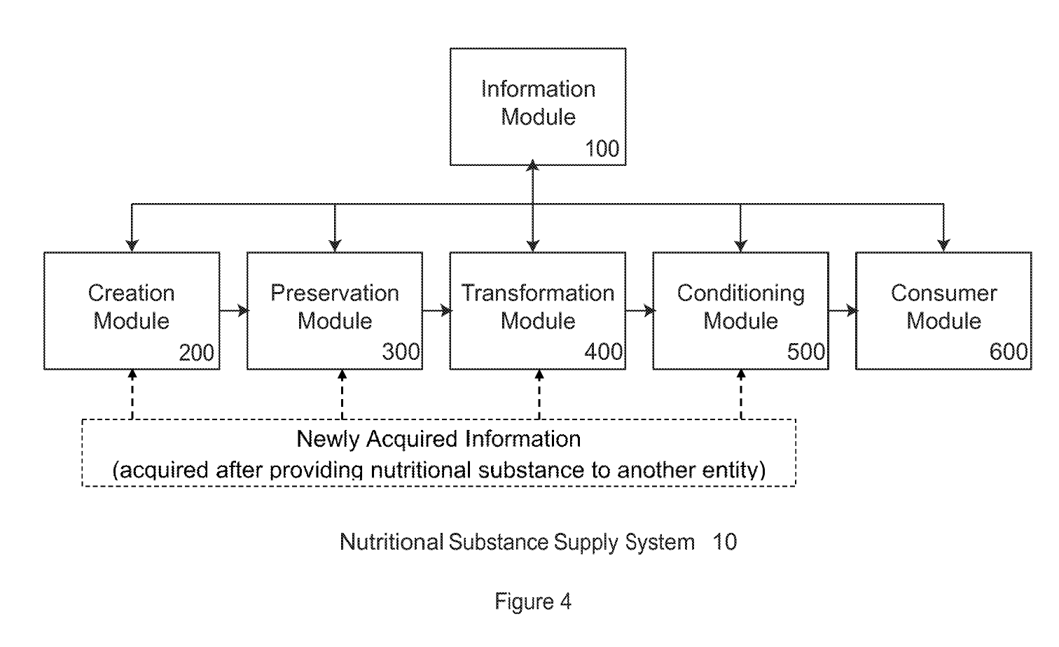

In FIG. 4, Information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network. Further, if the creation module 200 learns of a change in the information originally provided to information module 100, such as a deviation in a fertilizer or pesticide used or the water used for irrigation, the creation module 200 could update the labeling content related to those attributes and residing in the information module 100.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and corresponding initial nutritional, organoleptic, or aesthetic values of the corn and to whom the corn was delivered could also be collected. The farmer would provide such information to information module 100.

In the case where nutritional substance is beef hamburger meat, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. All such creation information would be provided by the rancher to information module 100.

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Further, if preservation module 300 dynamically modified its preservation of the nutritional substance during its preservation and shipment, information regarding how preservation module 300 dynamically modified itself during the period of preservation and shipment could be provided to information module 100. Still further, if the preservation module 300 learns of a change in the information originally provided to information module 100, such as a deviation in storage conditions, the preservation module 300 could update the labeling content related to those attributes and residing in the information module 100.

In the case where the nutritional substance is bananas, preservation module 300 could provide to information module 100 information about the current state of nutritional, organoleptic, or aesthetic values, or one or more ΔNs of the bananas, as well as the exterior and interior conditions of preservation module 300, as well modifications preservation module 300 made to itself to ripen or preserve the bananas during preservation so as to meet optimal nutritional, organoleptic, or aesthetic properties when the bananas arrive at the grocery store.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef.

Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information. Further, if the transformation module 400 learns of a change in the information it originally provided to information module 100, such as a deviation in component nutritional substance used, the transformation module 400 could update the labeling content related to those component nutritional substances and residing in the information module 100.

In the case where the nutritional substance is sweet corn which is to be cooked and canned for consumer consumption, transformation module 400 could use the creation information regarding the composition of the corn, including its nutrients and additives and any nutritional, organoleptic, or aesthetic values to determine how to transform the corn so as to preserve or improve organoleptic and nutritional properties. Transformation module 400 could also use preservation information regarding the corn to modify the transformation in response to changes to the corn which occurred during preservation so as to optimize at least one ΔN associated with the corn resulting from transformation. Additionally, information regarding how the corn was transformed in transformation module 400, such as cooking temperatures and duration and substances added to the canned corn, could be provided by transformation module 400 to information module 100.

Conditioning module 500 receives information regarding the nutritional substance from information module 100. This information could include creation information provided by creation module 200, preservation information provided by preservation module 300, and transformation information from transformation module 400. Additionally, conditioning module 500 could receive recipe information from information module 100. All such information could be used by conditioning module 500 in the conditioning of the nutritional substance so as to optimize at least one ΔN associated with the corn resulting from conditioning. Additionally, conditioning module 500 can provide information module 100 with conditioning information regarding how the nutritional substance was conditioned, as well as measured or sensed or estimated information as to the state of the nutritional substance before, during and upon completion of conditioning, or a ΔN associated with conditioning.

In the example of a frozen ready-to-eat dinner, conditioning module 500 could use such information provided by information module 100 to optimize the conditioning of the nutritional substance by conditioning module 500. Conditioning module 500 could dynamically adapt or modify the conditioning of the nutritional substance in response to information it receives from information module 100 regarding the nutritional, organoleptic, or aesthetic properties of the nutritional substance. Conditioning module 500 could use information about nutritional substances used as ingredients of the frozen ready-to-eat dinner, such as the transformed corn and beef described above, to modify the defrosting and cooking the frozen ready-to-eat dinner.

Consumer module 600 obtains consumer information from the consumer of the nutritional substance. Such consumer information could include feedback from the consumer as to the quality and taste of the nutritional substance, and could include feedback used to understand or determine a nutritional, organoleptic, or aesthetic value of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is canned Brussels sprouts, the Brussels sprouts would have creation information provided by creation module 200, preservation information from preservation module 300, and transformation information from transformation module 400 before being delivered to consumer module 600.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through creation module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database.

Information module 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Information module 100 could track the nutritional substances consumed to track and manage the diets of consumers. For example, a consumer who is on dialysis must manage the levels of certain chemicals in their blood for the dialysis to be effective. Information module 100 could track such information regarding nutritional substances being consumed. Additionally, information module 100 could provide information to consumer module 600 to assist in nutritional substance selection, including menu planning. This could include not only suggestions as to nutritional substances to be consumed, but also nutritional substances that should not be consumed and alerts or warnings when a consumer may be considering the purchase, consumption, or conditioning of a nutritional substance that should not be consumed. Further, such information from information module 100 could allow consumer module 600 to suggest compromises in the selection of nutritional substances.

Information module 100 is preferably implemented as a massive, multidimensional database operated on multiple computing devices across an interconnecting network. Such a database could be hosted by a plurality of nutritional substance creators, preservers, transformers, conditioners, or consumers. Preferably, information module 100 is maintained and operated by a global entity which operates the system for the benefit of all participants in the nutritional substance supply system 10. In such an information module 10, the global entity could be remunerated on a per-transaction basis for receiving nutritional substance information or providing nutritional substance information.

In another business model for the global entity operating information module 100, access to the module by participants in the supply chain could be at no charge. However, the global entity could receive remuneration for access by non-participants such as research and marketing organizations. Alternatively, participants in the supply chain could pay to advertise to other participants in the supply chain as part of their access to the information in information module 100.

Information transfer throughout nutritional substance supply system 10, to and from information module 100 can be accomplished through various computer information transmission systems, such as the internet. Such interconnection could be accomplished by wired networks and wireless networks, or some combination thereof. Wireless networks could include WiFi local area networks, Bluetooth networks, but preferably wireless telecommunication networks.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶ 6 will begin with the words “means for.” Accordingly, the applicant reserves the right to add additional claims after filing the application to pursue such additional claim forms for other aspects of the invention.

1. A label content update system for nutritional substances comprising:
a dynamic information identifier unique to a nutritional substance;
label content for the nutritional substance, wherein said label content is referenced by the dynamic information identifier;
means for updating the label content by a provider of the nutritional substance after the nutritional substance has been provided to another entity; and
means for retrieving the label content by at least one of a creator, preserver, transformer, or conditioner by referencing said dynamic information identifier.

2. A label content update system for nutritional substances according to claim 1 wherein:
said updating means and said retrieving means provide wireless communications.

3. A label content update system for nutritional substances according to claim 1 wherein:
said retrieving the label content may further be by a consumer.

4. A label content update system for nutritional substances comprising:
a dynamic information identifier unique to a nutritional substance, including a dynamic nutritional value database;
label content for the nutritional substance, wherein said label content is referenced by the dynamic information identifier;
means for updating the label content by a provider of the nutritional substance after the nutritional substance has been provided to another entity;
means relating the label content to ΔN information for said nutritional substance, and
means for retrieving the label content by at least one of a creator, preserver, transformer, or conditioner by referencing said dynamic information identifier.

5. A label content update system for nutritional substances according to claim 4 wherein:
said updating means and said retrieving means provide wireless communications.

6. A label content update system for nutritional substances according to claim 5 wherein:
said updates are retrieved by any of a creator, preserver, transformer, conditioner, or consumer.

7. A label content update system for nutritional substances according to claim 6 wherein:
said updates are retrieved using wireless communications.

8. A label content update system for nutritional substances comprising:
a consumer information system having consumer nutritional information;
a dynamic nutritional value database comprising at least a portion of label content for a nutritional substance, wherein
said label content is comprised of at least one of a ΔN and creation information and origin information for said nutritional substance, wherein
at least part of said portion of label content is capable of being updated by a creator or provider of the nutritional substance after the nutritional substance has been provided to another entity.

9. A label content update system for nutritional substances according to claim 8 wherein:
said consumer nutritional information further comprises consumer nutritional substance information.

10. A system for updating label content comprising:
a dynamic nutritional value database for storage of label content information for a nutritional substance, wherein
the label content is referenced by a dynamic information identifier or source information unique to said nutritional substance, wherein
the label content for the nutritional substance is further comprised of information provided by a creator or provider at a first time; and
changes to that information provided by said creator or provider at a subsequent time.

11. A system for updating label content according to claim 10 wherein:
said label content can be retrieved by any of a creator, preserver, transformer, conditioner, or consumer by referencing said dynamic information identifier or source information unique to said nutritional substance.

12. A system for updating label content comprising:
a dynamic nutritional value database for storage of label content information for a nutritional substance, wherein
the label content for the nutritional substance further comprises:
information provided by a creator or provider at a first time; and
changes to that information provided by said creator or provider at a subsequent time; and
a consumer information system comprising consumer information.

13. A system for updating label content according to claim 12 wherein:
said consumer information system further comprises consumer nutritional substance information.

14. A method for revising label content for a nutritional substance comprising:
accessing, by a creator or supplier of a nutritional substance, a database comprised at least in part of label content information for the nutritional substance further comprising at least a ΔN information; and
providing, by the creator or supplier of said nutritional substance, at a first time, said label content information; and
changing said label content information, by the creator or supplier, at a second time, following the first time; and
relating said label content information to a ΔN or creation information or origin information for the nutritional substance.

15. A method for revising label content for a nutritional substance according to claim 14 further comprising:
retrieving said label content information by using a reference unique to the nutritional substance.

16. A method for revising label content for a nutritional substance according to claim 15 wherein
said retrieving further comprises using telecommunications, wireless communications, or internet.

17. A method of updating label content for a nutritional substance comprising:
supplying a nutritional substance with a dynamic information identifier or source information unique to the nutritional substance;
populating a dynamic nutritional value database with label content information for said nutritional substance corresponding to said dynamic information identifier or source information unique to the nutritional substance;
acquiring new information related to the label content of said nutritional substance; and
updating the dynamic nutritional substance database with said new information.

18. A method of updating label content for a nutritional substance according to claim 17, wherein:
said step of updating the dynamic nutritional value database is accomplished using said dynamic information identifier or said source information unique to the nutritional substance.

19. A method of updating label content for a nutritional substance according to claim 18, including
relating said label content information to a ΔN or creation information or origin information for the nutritional substance.

20. A method of updating label content for a nutritional substance according to claim 19, wherein:
said step of updating the dynamic nutritional substance database is accomplished wirelessly.
